(19) United States
(12) Patent Application Publication
(10) Pub. No.: US 2008/0117892 A1
(43) Pub. Date: May 22, 2008

(54) Method for Iterative Routing with the Aid of a Path-Dependent Routing Metric

(75) Inventors: Michael Bahr, Munchen (DE); Martin Greiner, Neukeferloh (DE); Wolfram Krause, Oldenburg (DE); Rudolf Sollacher, Eching (DE)

Correspondence Address: STAAS & HALSEY LLP, SUITE 700, 1201 NEW YORK AVENUE, N.W., WASHINGTON, DC, 20005, US

(73) Assignee: Nokia Siemens Networks GmbH & Co. KG, Munich (DE)

(21) Appl. No.: 11/795,874

(22) PCT Filed: Nov. 23, 2005
(86) PCT No.: PCT/EP05/56161

§ 371 Date: Jul. 24, 2007

(30) Foreign Application Priority Data
Jan. 24, 2005 (DE) 10 2005 003 260.5

(51) Int. Cl. H04L 12/28

(52) U.S. Cl. 370/351

(57) ABSTRACT

A method detects a path in a communications network having a plurality of nodes with the aid of a routing metric. The method involves inputting a quantity determined on the basis of number of paths passing through the nodes in the routing metric.

### CROSS REFERENCE TO RELATED APPLICATIONS

This application is based on and hereby claims priority to PCT Application No. PCT/EP2005/056161 filed on Nov. 23, 2005 and German Application No. 10 2005 003 260.5 filed on Jan. 24, 2005, the contents of which are hereby incorporated by reference.

### BACKGROUND

The invention relates to a method for determining paths in a communications network comprising a plurality of nodes using a routing metric. The invention also relates to a device and a computer program product for implementing the method.

In communications networks messages are transmitted from the respective sender to one or more recipients. The communications network has nodes, which send and receive messages and in some instances forward them to an adjacent node. The specific configuration of the nodes and the connections between adjacent nodes is a function of the network in question. In the internet for example routers are connected together by way of lines, while in radio communications systems a radio interface connects adjacent radio stations.

If the sender and recipient of a message are not adjacent, the message is transmitted by way of a path passing by way of one or more nodes. To configure the message transmission sequence efficiently, a path is determined between sender and recipient before the message is transmitted. To this end it is known that nodes can store routing tables. These contain information, which forms the basis for decisions when determining the choice of route and forwarding messages in the network. The structure and content as well as the updating mechanisms of routing tables are essentially a function of the routing method deployed.

A routing metric is generally used when determining paths. This is used to evaluate different paths and to make the decision which path is to be used from a plurality of possible paths.

The document US 2003/0128687 A1 describes a routing algorithm, with which the path metric is determined by summing the node metrics of the nodes of the path. The following variables are used to calculate the node metric: the future traffic load from the adjacent nodes to a specific node and the future traffic load from the node to its adjacent nodes.

The document U.S. Pat. No. 4,905,233 describes a routing method, with which the length of the path is used as the metric. The traffic is distributed to the paths in inverse proportion to the path metrics.

### SUMMARY

One possible object is to demonstrate a method for determining paths in a communications network and a device and a computer program product for implementing said method.

The inventors propose a method for determining paths in a communications network comprising a plurality of nodes using a routing metric. A variable, which is determined from the number of paths passing by way of a node, is input into the routing metric.

A path through the communications network passes from a start or transmit node to a destination or recipient node. If the start and destination nodes are not adjacent, the path passes by way of one or more further nodes. A routing metric is used to evaluate paths, so that it is possible to decide between alternative paths using the routing metric. It is thus possible, from a plurality of alternative paths between a specific sender and a specific recipient, to use the path having the lowest routing metric value, in other words the shortest length according to the routing metric.

The variable, which is input into the routing metric, is determined from the number of paths passing by way of a node. In addition to the number of paths passing by way of a node, it is also possible to include other values or parameters in the determination of the variable, for example also the number of paths going out from the node, in other words also the number of paths, for which the respective node is the start node. Using the number of paths passing by way of a node and paths going out from a node corresponds to considering how often a specific node is the sending component of a path and thus describes the load on the node.

In addition to the described variable, further variables can also be input into the routing metric. In particular the described variable can be input into the routing metric in relation to a plurality of nodes. It is thus possible for example to form the routing metric by adding the described variable for all nodes, by way of which the path passes. Or the routing metric can be formed by adding the described variable for all nodes, by way of which the path passes, and for all nodes having a specific relationship to the nodes, by way of which the path passes.

For one or more nodes:

a first sum is determined from the number of paths passing by way of the node and paths going out from the node,
for every adjacent node of the respective node a second sum is determined from the number of paths passing by way of the respective adjacent node and paths going out from the respective adjacent node, and
a third sum is determined from the second sums of all adjacent nodes of the node and the first sum.

The routing metric of a path is preferably obtained from the sum of the third sum of all nodes, by way of which the path passes, or from the sum of the third sum of all nodes, by way of which the path passes, and the third sum of the transmit node of the path. In the second instance the third sums of all nodes, which transmit along the path, are summed, in other words the third sums of the original sender and the intermediate nodes between the original sender and the recipient.

In a refinement it is an iterative method, wherein the paths are determined using the routing metric and the routing metric is determined using the paths in an alternating manner. This procedure takes into account the fact that the routing metric is required to determine the paths, while the routing metric is however also a function of specific paths.

According to a particularly advantageous refinement the iterative method is implemented until the value of a variable converges. The iterative steps can be repeated until convergence is achieved, in other words the end to end data throughput and/or the end to end time delays or the paths and/or the routing metric no longer or scarcely change(s) from calculation to calculation.

It is advantageous if the method is applied to a communications network, wherein the nodes communicate with each other by radio, such as for example to a multihop adhoc radio communications system.

The facility has a determination unit to determine paths in a communications network comprising a plurality of nodes using a routing metric, with a variable, which is determined from the number of paths passing by way of a node, being input into the routing metric. The facility can for example be a node of the communications network or even a central facility, which is responsible for defining paths and informs the nodes about the determined paths.

The computer program product has a determination unit to determine paths in a communications network comprising a plurality of nodes using a routing metric, with a variable, which is determined from the number of paths passing by way of a node, being input into the routing metric. It can for example be deployed on a node of the communications network.

In the context of the proposed method a computer program product refers not only to the actual computer program (with its technical effect going beyond the standard physical interaction between program and computing unit) but in particular also to a recording medium for the computer program, a file collection, a configured computing unit and also for example a memory device or a server, on which the files belonging to the computer program are stored.

Both the facility and the computer program product are particularly suitable for implementing the method, it being possible to apply this also to refinements and developments.

### BRIEF DESCRIPTION OF THE INVENTION

These and other objects and advantages of the present invention will become more apparent and more readily appreciated from the following description of the preferred embodiments, taken in conjunction with the accompanying drawings of which:

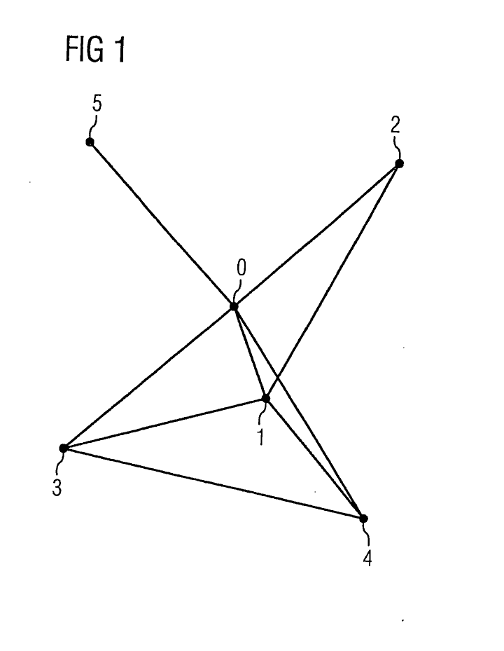

FIG. 1 shows a network comprising six nodes,

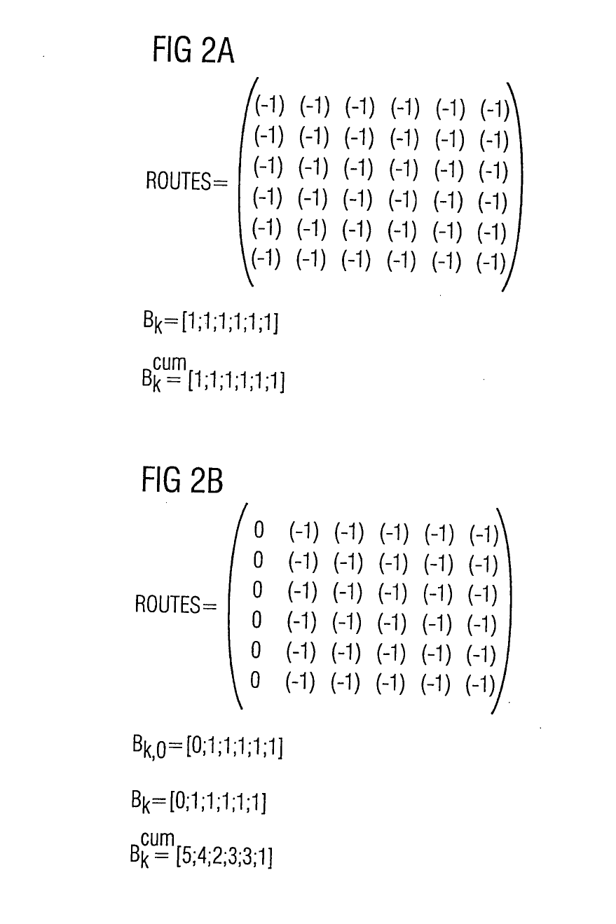

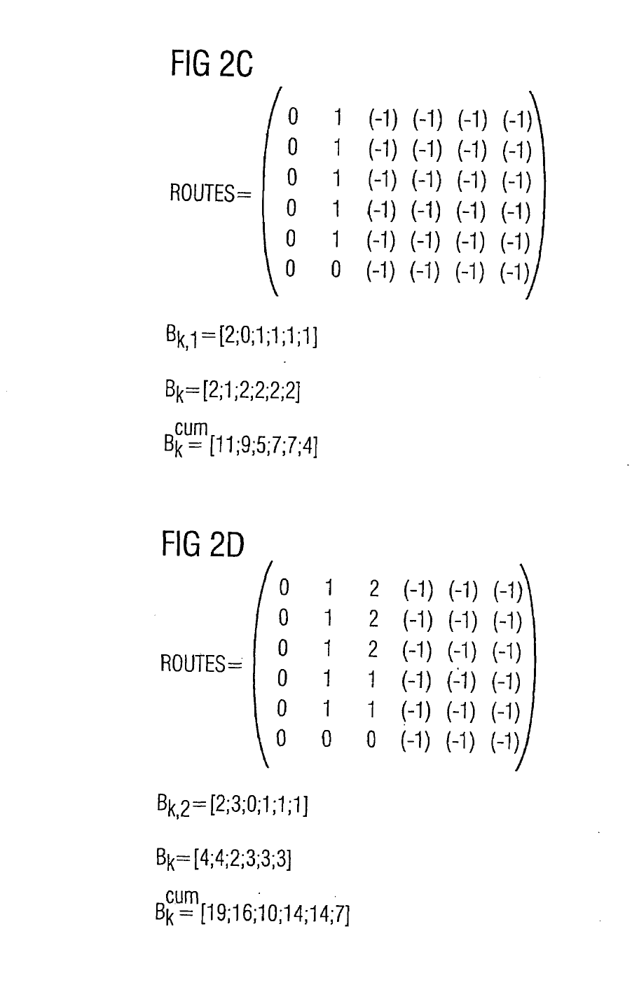

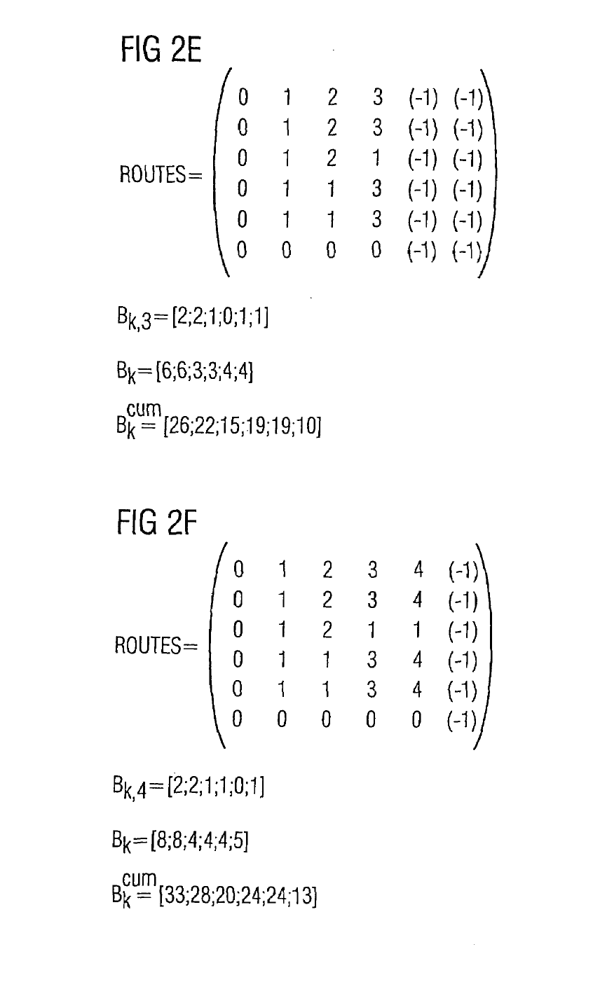

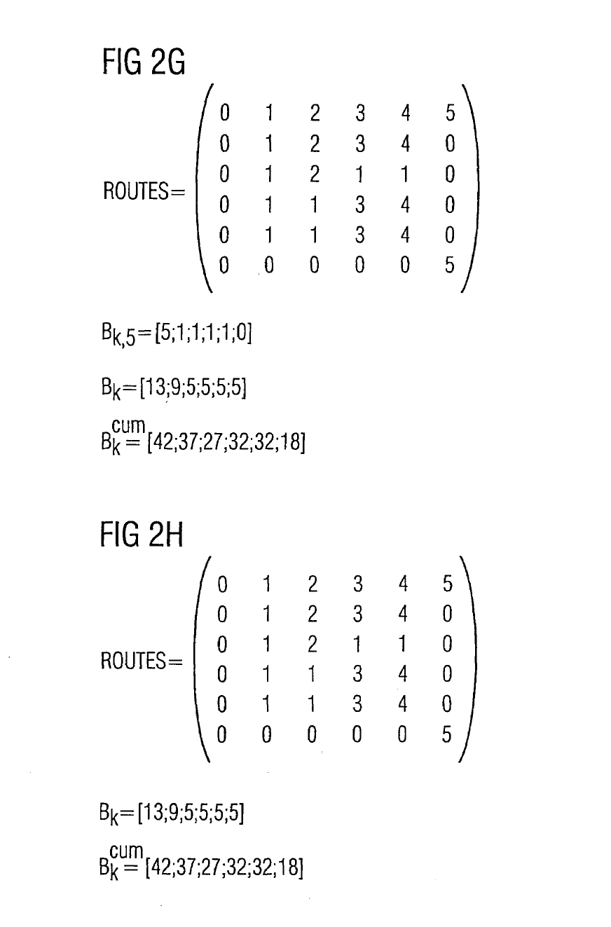

FIGS. 2a to 2h show steps of a first method sequence,

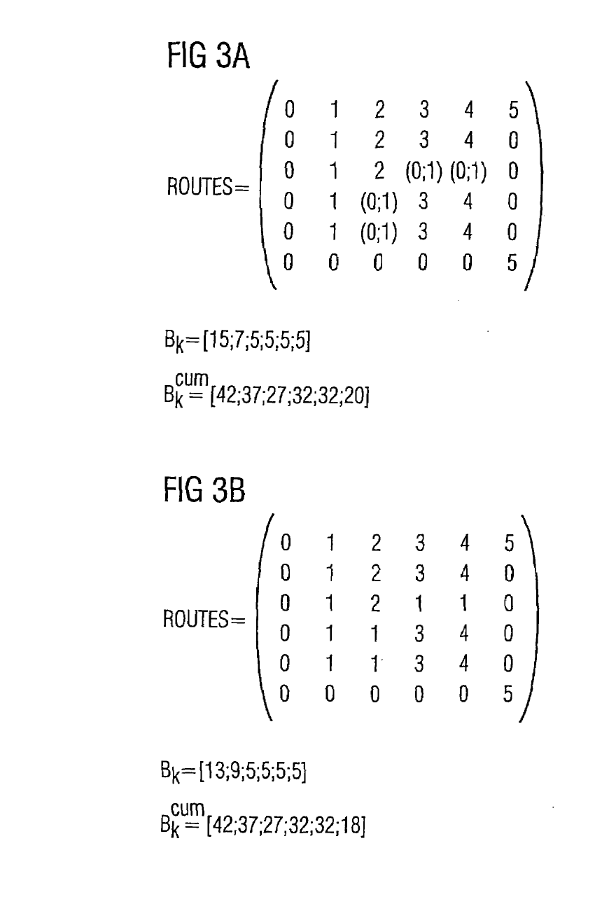

FIGS. 3a and 3b show steps of a second method sequence.\

### DETAILED DESCRIPTION OF THE PREFERRED

Reference will now be made in detail to the preferred embodiments of the present invention, examples of which are illustrated in the accompanying drawings, wherein like reference numerals refer to like elements throughout.

FIG. 1 shows a network comprising the nodes 0, 1, 2, 3, 4 and 5. The nodes of the network communicate with each other, with a common transmission medium being used, for example a common radio frequency. Lines connect adjacent nodes to each other, in other words those nodes, which can communicate directly with each other. The node 0 is adjacent to the nodes 1, 2, 3, 4 and 5, the node 1 is adjacent to the nodes 0, 2, 3 and 4, the node 2 is adjacent to the nodes 0 and 1, the node 3 is adjacent to the nodes 0, 1 and 4, the node 4 is adjacent to the nodes 0, 1 and 3, and the node 5 is adjacent to the node 0. The method is preferably deployed in larger networks but the description of the procedure is simplified for smaller networks, like the one shown in FIG. 1.

A path in the network passes from a start node to a destination node by way of no, one or a plurality of further nodes. For example therefore a path between the node 2 and the node 4 can pass by way of the node 0 or by way of the nodes 0 and 1.

A method is proposed below, wherein paths through the network are determined for all combinations of start and destination nodes. In other words a full routing table is determined for the network. Since generally a plurality of potential paths exist between a specific start node and a specific destination node, a weighting or evaluation of paths takes place by the length of the paths, which is ascertained by a routing metric. A known example of a routing metric is the hop-count metric, wherein the length of a path is given as the number of hops used by the path. In this instance short paths are preferred to longer ones.

To calculate the routing metric used below the number of paths going out from the respective node, in other words for which the respective node is the start node, and the number of paths passing by way of the respective node are determined for each node. This variable is hereafter referred to as Bₖ, where k is the index of the respective node. Each node is allocated the sum of its Bₖ and the Bₖ values of the nodes adjacent to it. This variable is hereafter referred to as Bₖ^{cum}, where k is the index of the respective node. The length of a path based on this routing metric is given as the sum of the Bₖ^{cum} values of the nodes sending along the path, in other words the transmit node and the nodes by way of which the path passes.

This selection of the routing metric is based on the fact that the variable Bₖ^{cum} is suitable for describing the medium access time of a node to the transmission medium shared by the nodes of the network. It is taken into account in particular here that a node cannot access the transmission medium, if an adjacent node is currently using the transmission medium to send or receive messages. This means that a node and a node adjacent to it cannot send and/or receive messages at the same time. The more adjacent nodes a node has, by way of which a plurality of paths pass, the longer it generally takes before said node can access the transmission medium.

The length of the path between the nodes 3 and 4, passing by way of the node 1, based on the routing metric, is for example:

### Path length 314=B₃^{cum}+B₁^{cum} where B₃^{cum}=B₃+B₀+B₁+B₄ B₁^{cum}=B₁+B₀+B₂+B₃+B₄.

The paths are input into a routing table in the form of a matrix, each column of the matrix corresponding to a specific destination node and each row of the matrix corresponding to a specific node sending or forwarding a message to this destination node. An entry z for the matrix element with the position (x,y) means that the node x has to send a message intended for the node y to the node z.

At the start of the method all Bₖ values and all Bₖ^{cum} values are set to the value 1. This corresponds to the hop-count metric. A value other than 1 can also be used as the initialization value, as the result of the method is largely independent of this start value. A value of (−1) is input into the routing table, if no path has yet been determined. This situation initially corresponds to the situation shown in FIG. 2a. Bₖ and Bₖ^{cum} are shown as vectors in FIG. 2a and the following figures, where Bₖ=[B₀,B₁,B₂,B₃,B₄,B₅] and Bₖ^{cum}=[B₀^{cum},B₁^{cum}, B₂^{cum},B₃^{cum},B₄^{cum},B₅^{cum}]. In the routing table ROUTES all entries are initially given the value (−1).

In the first step, shown in FIG. 2b, all the paths are considered, which lead to the node 0, in other words for which the node 0 is the destination node. Since all the nodes 0, 1, 2, 3, 4 and 5 are adjacent to the node 0, they send a message intended for the node 0 directly to the node 0. Therefore the first column of the routing table ROUTES has a 0 for all the rows. Looking at the nodes 3 and 4, it would also be possible for example for these to send a message intended for the node 0 to the node 1, which then forwards the message to the node 0. Generally a plurality of possible paths exist between two specific nodes. This means that when creating the routing table ROUTES a selection has to be made from the alternative paths. This selection is made using the routing metric described above, in other words, when selecting from the paths, the length of the paths is taken into account, as defined according to the variable Bₖ^{cum} determined in the previous step.

For the path between the node 3 and the node 0 the following consideration results:

Direct path from the node 3 to the node 0: the length of this path is B₃^{cum}=1, since the node 3, in other words the transmit node, is the only sending node along this path and the path does not pass by way of any further nodes.

Path between the node 3 and the node 0 by way of the node 1: the length of this path is B₃^{cum}+B₁^{cum}=2, since the path passes by way of the node 1, whose Bₖ^{cum} value has the value 1 according to FIG. 2a.

Path between the node 3 and the node 0 by way of the nodes 1 and 2: the length of this path is B₃^{cum}+B₁^{cum}+B₂^{cum}=3, since the path passes by way of the nodes 1 and 2, whose Bₖ^{cum} values respectively have the value 1 according to FIG. 2a.

The path with the shortest length according to the routing metric is selected. This corresponds to the direct path.

For every entry in the routing table ROUTES therefore all the possible paths are evaluated using the routing metric and the path with the lowest value for length according to the routing metric is selected and input into the routing table ROUTES. The different paths are evaluated here using the values of the routing metric defined in the last step.

After determining the routing table ROUTES the variable Bₖ^{cum} is calculated. To calculate Bₖ^{cum} the variable B_{k,0} is first calculated. This is the proportion of Bₖ, for which the node 0 is the destination node. Since the node 0 does not send messages to itself, there is a 0 at the first point of the vector B_{k,0}. Since according to the routing table ROUTES just one path goes out to the node 0 from the node 1 and no path exists, which passes by way of the node 1 to the node 0, there is a 1 at the second point. The same also applies to the nodes 2, 3, 4 and 5. Since until now only the node 0 has been considered to be the destination node, Bₖ is equal to B_{k,0}. Since Bₖ has been determined for all nodes, it is possible to calculate Bₖ^{cum}.

For the node 0 the following applies:

Bₖ^{cum}=B₀+B₁+B₂+B₃+B₄+B₅=0+1+1+1+1+1=5.

For the node 1 the following applies:

Bₖ^{cum}=B₀+B₁+B₂+B₃+B₄=0+1+1+1+1=4.

For the node 2 the following applies:

Bₖ^{cum}=B₀+B₁+B₂=0+1+1=2.

For the node 3 the following applies:

Bₖ^{cum}=B₀+B₁+B₃+B₄=0+1+1+1=3.

For the node 4 the following applies:

Bₖ^{cum}=B₀+B₁+B₃+B₄=0+1+1+1=3.

For the node 5 the following applies:

Bₖ=B₀+B₅=0+1=1.

In the second step, as shown in FIG. 2c, the node 1 is considered to be the destination node. As described above, the entries in the routing table ROUTES are determined by evaluating all the possible paths to the node 1 using the routing metric and selecting the most favorable path according to the routing metric. Accordingly the node 0 sends a message intended for the node 1 directly to the node 1, therefore there is a 1 at the position (0,1) of the routing table ROUTES. The same also applies to the other nodes 2, 3 and 4 adjacent to the node 1. The node 5 sends a message intended for the node 1 to the node 0, therefore there is a 0 at the position (5,1) of the routing table ROUTES.

To determine Bₖ^{cum}, B_{k,1} is first calculated. This is the proportion of Bₖ, for which the node 1 is the destination node. According to the routing table ROUTES a path goes out from the node 0 to the node 1 and a path passes to the node 1 by way of the node 0, namely the path from the node 5 to the node 1. There is therefore a 2 at the first point of B_{k,1}. Since the node 1 does not send messages to itself, there is a 0 at the first point of the vector B_{k,1}. There is a 1 in B_{k,1} for the nodes 2 to 5 respectively, since a path goes out from each of these nodes to the node 1 and no path passes by way of these nodes to the node 1.

Bₖ is calculated by adding B_{k,0} from FIG. 2b, in other words the proportion of Bₖ, for which the node 0 is the destination node, and B_{k,1} from FIG. 2c, in other words the proportion of Bₖ, for which the node 1 is the destination node. It is then possible to calculate Bₖ^{cum} from Bₖ, as described above. The following applies for the node 1 for example:

Bₖ^{cum}=B₀+B₁+B₂+B₃+B₄=2+1+2+2+2=9.

FIG. 2d shows the third step, in which the node 2 is considered to be the destination node, FIG. 2e shows the fourth step, in which the node 3 is considered to be the destination node, FIG. 2f shows the fifth step, in which the node 4 is considered to be the destination node, and FIG. 2g shows the sixth step, in which the node 5 is considered to be the destination node. In each instance the routing table ROUTES is first filled in further by determining, using the routing metric, the node to which a message intended for the respective destination node is to be sent. During this determination the Bₖ^{cum} determined in the previous step is used, in other words the entries are selected taking into account the routing metric predetermined by Bₖ^{cum}. The variable Bₖ^{cum} is then calculated based on the new routing table ROUTES.

The procedure described is an iterative method, since on the one hand the routing metric by way of the variable Bₖ^{cum} is input when determining the paths and therefore when creating the routing table ROUTES and on the other hand the determined paths are input into the routing metric by way of the variable Bₖ^{cum}. The routing table ROUTES and the routing metric are therefore updated in an alternating manner.

FIGS. 2b to 2g showed a first round of calculations to determine the paths through the network, starting with consideration of the node 0 as the destination node and continuing by way of the nodes 1, 2, 3, 4 to the node 5. Alternatively a different sequence can also be used. After the first round a second round can be carried out, again starting with the node 0 as the destination node. Thus in the first step of the second round the first column of the routing table ROUTES is redetermined, with the routing metric according to the variable Bₖ^{cum} from the last step of the first round being used. Bₖ and Bₖ^{cum} are then determined. The method also proceeds correspondingly in respect of the nodes 1, 2, 3, 4 and 5 as destination node, with the routing metric being taken from the respectively preceding step of the second round in each instance. The situation according to FIG. 2h then results at the end of the second round.

Further rounds of calculations can follow if required. During the course of the rounds the result converges, in other words the entries in the routing table ROUTES and the variables Bₖ and Bₖ^{cum} no longer or only slightly change. After two rounds a self-consistent routing table ROUTES is generally already calculated. During further iteration rounds the entries in the routing table ROUTES may still change but there is no further significant increase in the output of the network, measured for example using the end to end data throughput and the end to end time delay. The number of rounds required to achieve convergence is a function of the size of the network in question.

FIGS. 3a and 3b show the steps of an alternative calculation sequence. The initialization state corresponds to that of FIG. 2a. In the first round the node 0 is considered to be the destination node in a first step and the first column of the routing table ROUTES is filled in. To select from the different possible paths, Bₖ^{cum} from the previous round is used, in other words Bₖ^{cum} from the initialization. Bₖ and Bₖ^{cum} are then not recalculated. Rather in the second step the node 1 is considered to be the destination node and the second column of the routing table ROUTES is determined, with Bₖ^{cum} from the initialization again being used. The same also takes place in respect of the nodes 2, 3, 4 and 5 as destination nodes. The values Bₖ^{cum} of the initialization are thus used for all the entries of the routing table ROUTES of the first round.

Once the routing table ROUTES has been determined as part of the first round, as shown in FIG. 3a, Bₖ and Bₖ^{cum} are calculated based on this routing table ROUTES, as shown in FIG. 3a.

Some entries in the routing table ROUTES have two entries after the first round. This occurs when the routing metric for these two paths is the same, in other words the paths are degenerate. This situation can in principle also occur with the method described with reference to FIGS. 2a to 2h. This equivalence of a plurality of routes between two specific nodes generally disappears in the course of subsequent calculation rounds.

FIG. 3b shows the result of the second round. In the second round the entries for the routing table ROUTES are determined first for the node 0, then for the node 1, then for the node 2, then for the node 3, then for the node 4, and finally for the node 5 as destination node, with the Bₖ^{cum} values calculated at the end of the first round being used respectively to evaluate the routes. After determining the routing table ROUTES of the second round, Bₖ and Bₖ^{cum} are calculated based on this routing table ROUTES, as shown in FIG. 3b.

The second variant of the method shown in FIGS. 3a and 3b has the advantage that the calculation outlay is lower, since Bₖ^{cum} only has to be determined once per round and not after every step, as provided for in the first variant. However a larger number of rounds is generally required with the second variant, before convergence is achieved.

The calculated paths of the routing table ROUTES in FIG. 2 and FIG. 3 are used to send messages between the nodes 0, 1, 2, 3, 4 and 5. It is then necessary to recalculate the paths, if the topology of the network changes, in other words if the adjacency relationships between the nodes change or if nodes are added to the network or if nodes leave the network.

To determine the paths, it is assumed that the facility making the calculation knows the complete topology of the network. This can for example be achieved in that every node collects information about its adjacent nodes and passes on this “link state” information known to it to its adjacent nodes or to a central facility. The method, according to which information about the network topology is collected and passed on, has no influence on the method for determining the paths.

The paths can be calculated by one node of the network, which forwards the result to the other nodes. A central facility, which knows the topology of the network, can also determine the paths according to the proposed methods. It is also possible for a plurality of nodes or every node of the network to make the proposed calculations. Since the nodes assume the same network topology and use the same algorithm to calculate the paths, they also determine the same result.

Instead of the calculated routing table ROUTES it is also possible to pass on the calculated variable Bₖ^{cum}, so that the nodes determine the routing table ROUTES based on the received variable Bₖ^{cum}.

The described methods, with which the routing metric and respectively the length of the paths are determined from the sum of the Bₖ^{cum} values of the sending nodes of a path, result in the determination of paths, in which critical nodes, by way of which a plurality of paths pass and which are correspondingly significantly loaded, have their load reduced. Thus for example paths determined according to the method switch to edge nodes, with the result that the paths are longer than when nodes in the center of the network are used, but the load on the paths is smaller. Use of the routing metric results in a higher end to end data throughput and a reduced end to end time delay.

The method can be used in any networks, in which the nodes communicate with each other. They are used particularly advantageously in radio communications systems, such as multihop adhoc systems and sensor networks.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-6. (canceled)

7. A method for determining paths and evaluating a proposed path in a communications network comprising a plurality of nodes, the method using a routing metric, comprising:
determining a first sum as a number of paths involving a node, the paths involving the node including both paths passing through the node and paths beginning at the node;
for each adjacent node that is adjacent to the respective node, determining a second sum from the number of paths involving the adjacent node;
determining a third sum from the second sums of all adjacent nodes of the node and the first sum; and
inputting to the routing metric as a routing variable the sum of all third sums of nodes through which the path passes, and the third sum of a beginning node of the path.

8. The method as claimed in claim 7, wherein an iterative method is used, with which proposed paths are determined using the routing metric and the routing metric is determined using the proposed paths in an alternating manner.

9. The method as claimed in claim 8, wherein the iterative method is implemented, until the value of a variable, in particular the end to end data throughput and/or the end to end time delay, converges.

10. The method as claimed in claim 7, wherein the nodes of the communications network communicate with each other by radio.

11. The method as claimed in claim 7, wherein the number of paths includes both existing paths and the proposed path.

12. The method as claimed in claim 9, wherein the nodes of the communications network communicate with each other by radio.

13. The method as claimed in claim 12, wherein the number of paths includes both existing paths and the proposed path.

14. A method for determining paths and evaluating a proposed path in a communications network comprising a plurality of nodes, the method using a routing metric, comprising:
determining a first sum as a number of paths involving a node, the paths involving the node including both paths passing through the node and paths beginning at the node;
for each adjacent node that is adjacent to the respective node, determining a second sum from the number of paths involving the adjacent node;
determining a third sum from the second sums of all adjacent nodes of the node and the first sum; and
inputting to the routing metric as a routing variable the sum of all third sums for nodes through which the proposed path passes.

15. The method as claimed in claim 14, wherein an iterative method is used, with which proposed paths are determined using the routing metric and the routing metric is determined using the proposed paths in an alternating manner.

16. The method as claimed in claim 15, wherein the iterative method is implemented, until the value of a variable, in particular the end to end data throughput and/or the end to end time delay, converges.

17. The method as claimed in claim 14, wherein the nodes of the communications network communicate with each other by radio.

18. The method as claimed in claim 14, wherein the number of paths includes both existing paths and the proposed path.

19. The method as claimed in claim 16, wherein the nodes of the communications network communicate with each other by radio.

20. The method as claimed in claim 19, wherein the number of paths includes both existing paths and the proposed path.

21. A system to determine paths and evaluate a proposed path in a communications network comprising a plurality of nodes, the system using a routing metric, the system comprising:
a first determination unit to determine as a first sum a number of paths involving a node, the paths involving the node including both paths passing through the node and paths beginning at the node;
a second determination unit, for every adjacent node that is adjacent to the respective node, to determine a second sum from the number of paths involving the adjacent node;
a third determination unit to determine a third sum from the second sums of all adjacent nodes of the node and the first sum; and
an input unit to input to the routing metric as a routing variable, the sum of all third sums of nodes through which the path passes, or the sum of all third sums of nodes through which the paths passes, and the third sum of a beginning node of the path.

22. A computer readable storage medium storing a program to control a computer to perform a method for determining paths and evaluating a proposed path in a communications network comprising a plurality of nodes, the method comprising:
determining a first sum as a number of paths involving a node, the paths involving the node including both paths passing through the node and paths beginning at the node;
for each adjacent node that is adjacent to the respective node, determining a second sum from the number of paths involving the adjacent node;
determining a third sum from the second sums of all adjacent nodes of the node and the first sum; and
inputting to the routing metric as a routing variable, the sum of all third sums of nodes through which the path passes, or the sum of all third sums of nodes through which the paths passes, and the third sum of a beginning node of the path.
